(19) United States
(12) Patent Application Publication
(10) Pub. No.: US 2008/0114938 A1
(43) Pub. Date: May 15, 2008

(54) Application Message Caching In A Feed Adapter

(76) Inventor: Kenneth W. Borgendale, Austin, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/559,425

(22) Filed: Nov. 14, 2006

(51) Int. Cl. G06F 12/08

(52) U.S. Cl. 711/118; 711/E12.017

(57) ABSTRACT

Methods, apparatus, and products are disclosed for application message caching in a feed adapter that include providing a feed adapter capable of converting application messages having an input message format to application messages having an output message format, the feed adapter comprising a feed adapter cache and a plurality of caching functions for administering the feed adapter cache; establishing, on the feed adapter, a configuration policy that specifies a caching rule using at least one of the caching functions; receiving, in the feed adapter, an application message having the input message format; and storing, by the feed adapter, the application message having the input message format in the feed adapter cache according to the caching rule of the configuration policy.

### BACKGROUND OF THE INVENTION

1. Field of the Invention

The field of the invention is data processing, or, more specifically, methods, apparatus, and products for application message caching in a feed adapter.

2. Description of Related Art

Messaging environments are generally available to provide data communication between message sending devices and message receiving devices using application messages. An application message is a quantity of data organized into one or more data fields and is passed from a message producer installed on a message sending device to a message consumer installed on a message receiving device. An application message is a form of message recognized by application software operating in the application layer of a data communication protocol stack—as contrasted for example with a transport message or network message which are forms of messages recognized in the transport layer and the network layer respectively. An application message may represent, for example, numeric or textual information, images, encrypted information, and computer program instructions. In a financial market data environment, an application message is commonly referred to as a ‘tick’ and includes financial market data such as, for example, financial quotes or financial news. Financial quotes include bid and ask prices for any given financial security. A ‘bid’ refers to the highest price a buyer is willing to pay for a security. An ‘ask’ refers to the lowest price a seller is willing to accept for a security. Often in messaging environments, message formats recognized by message sending devices are not recognized by message receiving devices. Such messaging environments typically include feed adapters to perform application message conversion between message formats. The basic task of the feed adapter is to receive an application message having an input message format from a message sending device, convert the application message having the input format to an application message having an output format, and transmit the application message having the output format to a message receiving device.

During the conversion process, a feed adapter may store application message data and data derived from the messages in a cache to perform in-line conversion calculations and process information requests from message receiving devices. In a financial market data environment, for example, a feed adapter may calculate and store the total number of shares of IBM stock traded for the day in the cache as the feed adapter receives application messages from the message sending device. The feed adapter may then incorporate the total number of shares of IBM stock traded for the day into the converted application messages that the feed adapter transmits to message receiving devices. Similarly, a feed adapter may calculate and store the last sale price for shares of IBM stock and provide this last sale price to a message receiving device that request such information. A message receiving device may occasionally make such a request from a feed adapter when the message receiving device fails to receive the original application message that contains such data or when the message receiving device subscribes to a message stream from the feed adapter after the original message was transmitted.

In current messaging environments, software architects typically configure feed adapters to perform application message caching using a fixed cache structure and a fixed set of caching algorithms. The fixed cache structure and the fixed set of caching algorithms are often hard-coded into a conversion or caching module on the feed adapter. Any changes made to the cache structure or the caching algorithms typically require extensive recoding of the conversion or caching module and subsequence recompilation of the new computer code. In fact, even slight modifications to current feed adapters often involve substantial financial and human resources. Readers will, therefore, appreciate that room for improvement exists for application message caching in a feed adapter.

### SUMMARY OF THE INVENTION

Methods, apparatus, and products are disclosed for application message caching in a feed adapter that include providing a feed adapter capable of converting application messages having an input message format to application messages having an output message format, the feed adapter comprising a feed adapter cache and a plurality of caching functions for administering the feed adapter cache; establishing, on the feed adapter, a configuration policy that specifies a caching rule using at least one of the caching functions; receiving, in the feed adapter, an application message having the input message format; and storing, by the feed adapter, the application message having the input message format in the feed adapter cache according to the caching rule of the configuration policy. Storing, by the feed adapter, the application message having the input message format in the feed adapter cache according to the caching rule of the configuration policy may include calling each of the caching functions used to specify the caching rule of the configuration policy in dependence upon the application message having the input message format.

Application message caching in a feed adapter may also include retrieving, by the feed adapter, an application message having the output message format from the feed adapter cache according to the caching rule of the configuration policy; and transmitting, by the feed adapter to a message receiving device on a message stream, the retrieved application message. Retrieving, by the feed adapter, an application message having the output message format from the feed adapter cache according to the caching rule of the configuration policy may also include calling each of the caching functions used to specify the caching rule of the configuration policy; receiving, in return from each of the called caching functions, a value; and storing each of the received values in the application message having the output message format.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network and block diagram illustrating an exemplary system for application message caching in a feed adapter according to exemplary embodiments of the present invention.

FIG. 2 sets forth a block diagram of automated computing machinery comprising an exemplary feed adapter useful in application message caching in a feed adapter according to exemplary embodiments of the present invention.

FIG. 3 sets forth a flowchart illustrating an exemplary method for application message caching in a feed adapter according to exemplary embodiments of the present invention.

FIG. 4 sets forth a flowchart illustrating a further exemplary method for application message caching in a feed adapter according to exemplary embodiments of the present invention.

FIG. 5 sets forth a flowchart illustrating a further exemplary method for application message caching in a feed adapter according to exemplary embodiments of the present invention.

### DETAILED DESCRIPTION OF EXEMPLARY EMBODIMENTS

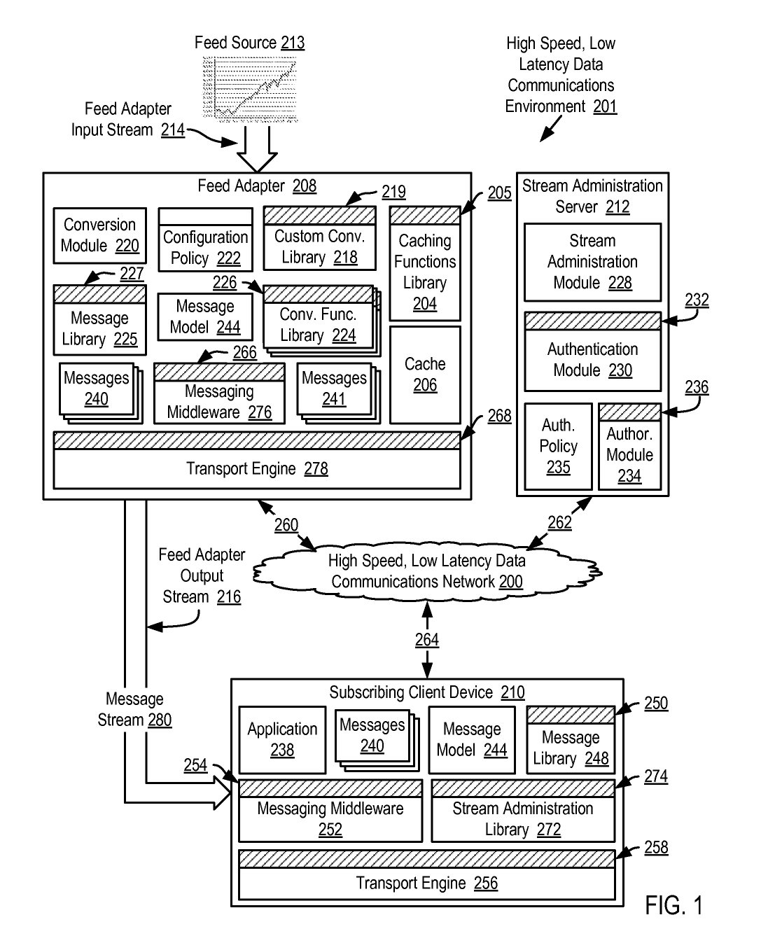

Exemplary methods, apparatus, and products for application message caching in a feed adapter according to embodiments of the present invention are described with reference to the accompanying drawings, beginning with FIG. 1. FIG. 1 sets forth a network and block diagram illustrating an exemplary system for application message caching in a feed adapter according to embodiments of the present invention. The system of FIG. 1 operates generally to application message caching in a feed adapter according to embodiments of the present invention as follows: A feed adapter (208) capable of converting application messages having an input message format to application messages having an output message format is provided. The feed adapter (208) includes a feed adapter cache (206) and a plurality of caching functions for administering the feed adapter cache (206). A configuration policy (222) is established that specifies a caching rule using at least one of the caching functions. The feed adapter (208) receives an application message having the input message format. The feed adapter (208) stores the application message having the input message format in the feed adapter cache (206) according to the caching rule of the configuration policy (222). The feed adapter (208) may also retrieve an application message having the output message format from the feed adapter cache (206) according to the caching rule of the configuration policy (222) and may transmit the retrieved application message to a message receiving device on a message stream (280). In the example of FIG. 1, the message receiving device (210) is implemented as a subscribing client device.

The high speed, low latency data communications environment (201) illustrated in FIG. 1 includes a high speed, low latency data communications network (200). The network (200) includes a feed adapter (208), a stream administration server (212), and a subscribing client device (210), as well as the infrastructure for connecting such devices (208, 212, 210) together for data communications. The network (200) of FIG. 1 is termed ‘high speed, low latency’ because the application messages sent between devices connected to the network (200) on message streams administered by the stream administration server (212) bypass the stream administration server (212). For example, the application messages on the message stream (280) from the feed adapter (208) to the subscribing client device (210) bypass the stream administration server (212). Although such messages are not delayed for processing in the stream administration server (212), the stream administration server (212) retains administration of the stream (280) between devices connected to the high speed, low latency data communications network (200).

Further contributing to the ‘high speed, low latency’ nature of network (200), readers will note that the network (200) does not include a router, that is a computer networking device whose primary function is to forward data packets across a network toward their destinations. Rather, each device (208, 212, 210) provides its own routing functionality for data communication through a direct connection with the other devices connected to the network (200). Because the network (200) does not include a computer networking device dedicated to routing data packets, the network (200) of FIG. 1 may be referred to as a ‘minimally routed network.’ Although the exemplary network (200) illustrated in FIG. 1 does not include a router, such a minimally routed network is for explanation only. In fact, some high speed, low latency networks useful in application message caching in a feed adapter according to embodiments of the present invention may include a router.

The high speed, low latency data communications environment (201) depicted in FIG. 1 includes a message stream (280). A message stream is a data communication channel between a communications endpoint of a sending device and a communications endpoint of at least one receiving device. A communications endpoint is composed of a network address and a port for a sending device, such as a feed adapter, or a receiving device, such as a subscribing client device. A message stream may be implemented as a multicast data communication channel. In a multicast data communication channel, a one-to-many relationship exists between a destination address for a message and the communication endpoints of receiving devices. That is, each destination address identifies a set of communication endpoints for receiving devices to which each message of the stream is replicated. A multicast data communication channel may be implemented using, for example, the User Datagram Protocol (‘UDP’) and the Internet Protocol (‘IP’). In addition to a multicast data communication channel, the message stream may be implemented as a unicast data communication channel. In a unicast data communication channel, a one-to-one relationship exists between a destination address for a message and a communication endpoint of a receiving device. That is, each destination address uniquely identifies a single communication endpoint of single receiving device. A unicast data communication channel may be implemented using, for example, the Transmission Control Protocol (‘TCP’) and IP.

The exemplary system of FIG. 1 includes a stream administration server (212) connected to the high speed, low latency data communications network (200) through a wireline connection (262). The stream administration server (212) of FIG. 1 is a computer device having installed upon it a stream administration module (228), an authentication module (230), an authorization module (234), and an authorization policy (235). A stream administration module (228) is a software component that includes a set of computer program instructions configured for application message caching in a feed adapter according to embodiments of the present invention. The stream administration module (228) operates generally for application message caching in a feed adapter according to embodiments of the present invention by brokering establishment of a message stream (280) from the feed adapter (208) to the message receiving device (210). In addition, the stream administration module (228) administers the message stream by providing security services such as authenticating the subscribing client device (210) and authorizing the subscribing client device (210) to receive application messages from the feed adapter (208) on the message stream (280).

The authentication module (230) of FIG. 1 is a set of computer program instructions capable of providing authentication security services to the stream administration module (228) through an exposed authentication application programming interface (‘API’) (232). Authentication is a process of verifying the identity of an entity. In the exemplary system of FIG. 1, the authentication module (230) verifies the identity of the subscribing client device (210). The authentication module (230) may provide authentication security services using a variety of security infrastructures such as, for example, shared-secret key infrastructure or a public key infrastructure.

The authorization module (234) of FIG. 1 is a set of computer program instructions capable of providing authorization security services to the stream administration module (228) through an exposed authorization API (236). Authorization is a process of only allowing resources to be used by resource consumers that have been granted authority to use the resources. In the example of FIG. 1, the authorization module (234) identifies the application messages that the subscribing client device (210) is authorized to receive on the message stream (280). The authorization module (234) of FIG. 1 provides authorization security services using an authorization policy (235). The authorization policy (235) is a set of rules governing the privileges of authenticated entities to send or receive application messages on a message stream. In a financial market data environment, for example, an authenticated entity may be authorized to receive application messages that include financial quotes for some financial securities but not other securities. The authorization policy (235) may grant privileges on the basis of an individual entity or an entity's membership in a group.

In the exemplary system of FIG. 1, the feed adapter (208) is connected to the high speed, low latency data communications network (200) through a wireline connection (260). The feed adapter (208) is a computer device having the capabilities of converting application messages (241) on a feed adapter input stream (214) having an input message format to application messages (240) on a feed adapter output stream (216) having an output message format and transmitting the application messages on the feed adapter output stream (216) to subscribing client devices. The feed adapter input stream (214) is a message stream from a feed source to the feed adapter (208). The feed adapter output stream (216) is a message stream administered by the stream administration server (212) from the feed adapter (208) to the subscribing client device (210).

In the example of FIG. 1, the feed adapter (208) receives application messages (241) having an input message format on the feed adapter input stream (214) from a feed source (213). The feed source (213) is a computer device capable of aggregating data into application messages and transmitting the messages to a feed adapter. In a financial market data environment, for example, a feed source (213) may be implemented as a feed source controlled by the Options Price Reporting Authority (‘OPRA’). OPRA is the securities information processor for financial market information generated by the trading of securities options in the United States. The core information that OPRA disseminates is last sale reports and quotations. Other examples of feed sources in financial market data environment may include feed sources controlled by the Consolidated Tape Association (‘CTA’) or The Nasdaq Stock Market, Inc. The CTA oversees the dissemination of real-time trade and quote information in New York Stock Exchange and American Stock Exchange listed securities. The Nasdaq Stock Market, Inc. operates the NASDAQ Market Center_{SM} which is an electronic screen-based equity securities market in the United States. In a financial market data environment, a feed adapter input stream is referred to as a ‘financial market data feed.’

The feed adapter (208) of FIG. 1 has installed upon it a conversion module (220), a custom conversion library (218), a configuration policy (222), conversion function libraries (224), a message library (225), a message model (244), messaging middleware (276), and a transport engine (278). The conversion module (220) is a software component that includes a set of computer program instructions for providing basic feed adapter operation. The conversion module (220) of FIG. 1 initializes the feed adapter, loads common conversion function libraries, and loads the custom conversion library (218). The common conversion function libraries contain conversion functions that the feed adapter typically utilizes regardless of the feed sources providing application messages.

The custom conversion library (218) of FIG. 1 is a software component that includes computer program instructions for extending feed adapter functionality to utilize a particular feed source such as, for example, the feed source (213). The conversion module (220) utilizes the custom conversion library (218) through API (219) exposed by the custom conversion library (218). The custom conversion library (218) provides access the feed source (213), administers the feed adapter input stream (214) from the feed source (213), and performs application message conversion. To perform application message conversion, the custom conversion library (218) typically loads conversion functions libraries (224) specified in the configuration policy (222) and utilizes the conversion functions contained on those loaded libraries.

The custom conversion library (218) of FIG. 1 also includes a set of computer program instructions for application message caching according to embodiments of the present invention. The custom conversion library (218) operates generally for application message caching according to embodiments of the present invention by storing application messages (241) having the input message format in the feed adapter cache (206) according to the caching rule of the configuration policy (222). The custom conversion library (218) also operates generally for application message caching according to embodiments of the present invention by retrieving an application message (240) having the output message format from the feed adapter cache according to the caching rule of the configuration policy (222). To perform application message caching, the custom conversion library (218) typically loads a caching functions library (204) and utilizes the caching functions contained in the library (204).

In the example of FIG. 1, the custom conversion library (218) may be implemented as a dynamically linked library available to the conversion module (220) at runtime, dynamically loaded Java classes, or any other implementation as will occur to those of skill in the art. Although the description above indicates that the functionality provided by the custom conversion library (218) is contained in a software module distinct from the conversion model (220), readers will note that features of both the conversion module (220) and the custom conversion library (218) may overlap or be combined into a single software module.

The configuration policy (222) of FIG. 1 is a data structure that specifies a caching rule using at least one of the caching functions of the caching functions library (204). A caching rule is a data structure that contains a set of instructions for administering a feed adapter cache. The custom conversion library (218) may perform the set of instructions contain in a caching rule when conditions specified in the caching rule are satisfied. In addition to specifying a caching rule, the configuration policy (222) of FIG. 1 also specifies a conversion rule from an input message format to an output message format using one or more of the conversion functions of the conversion function libraries (224). Utilizing multiple conversion rules in a configuration policy (222), the custom conversion library (218) may convert messages from a variety of input formats to a variety of output formats. In the example of FIG. 1, the configuration policy (222) specifies a caching rule for administering the feed adapter cache (206) and specifies a conversion rule for converting the application message (241) received from the feed adapter input stream (214) having an input format to application messages (240) having an output format for transmission to subscribing client devices on the feed adapter output stream (216).

In the example of FIG. 1, the configuration policy (222) is typically established on the feed adapter (208) by a system administrator. The configuration policy (222) may, however, be established on the feed adapter (208) by the stream administration server (212) when the message stream (280) is brokered, or be established on the feed adapter (208) by any other entity as will occur to those of skill in the art. The configuration policy (222) of FIG. 1 may be implemented using a structured document such as, for example, an eXtensible Markup Language (‘XML’) document. However, the custom conversion library (218) typically converts a configuration policy to a binary table for optimal runtime performance.

The feed adapter cache (206) of FIG. 1 is a collection of data derived from application messages transiently or permanently stored elsewhere in the feed adapter. Accessing such data from the feed adapter cache (206) provides relatively faster access times than retrieving or computing the data from the application messages themselves each time such data is requested. Once the data is derived from the application messages and stored in the cache (206), subsequent use of the data may be made by accessing the cache (206) rather than retrieving or computing the data from the application messages. In fact, when the application messages no longer exist on the feed adapter, the ability to retrieve or compute the data from the application messages themselves is typically unavailable. Because the application messages and data derived from such message may only be stored transiently in the feed adapter, readers will note that the term ‘cache’ does not imply that the data stored in the cache permanently exists elsewhere on a feed adapter. In this specification, therefore, the term ‘cache’ also encompasses the functionality provided by an in-memory database because the transiently stored application messages from which data in the cache is retrieved or calculated may only exist on the feed adapter outside the cache for a brief period of time. That is, the data stored in the cache (206) may only exist on the feed adapter (208) outside the cache (206) long enough to convert the data in an application message (241) having an input format to an application message (240) having an output format. Subsequent use of the data may, therefore, only be made by accessing the cache (206).

The caching functions library (204) is a loadable software module that contains one or more caching functions for administering the feed adapter cache (206). The caching functions contained in the caching functions library (204) may, for example, configure the structure of the cache (206), empty the cache (206), retrieve a value from the cache (206), store a value in the cache (206), and so on. The custom conversion library (218) accesses the caching functions through an API (205) exposed by the caching functions library (204). In the example of FIG. 1, the caching functions library (204) may be implemented as dynamically linked libraries available to the custom conversion library (218) or the conversion module (220) at runtime, dynamically loaded Java classes, or any other implementation as will occur to those of skill in the art.

The conversion function libraries (224) of FIG. 1 are loadable software modules that each contain one or more conversion functions capable of converting data in an application message from one format to another format or converting values of data fields from one value to another value. The conversion functions contained in the conversion function libraries may, for example, convert a 16-bit integer to a 32-bit integer, convert a number stored in a string field to a 64-bit double floating point value, increase the value of one data field by one, or any other conversion as will occur to those of skill in the art. The custom conversion library (218) accesses the conversion functions through a set of conversion function APIs (226) exposed by the conversion functions of the conversion function libraries (224). In the example of FIG. 1, the conversion function libraries (224) may be implemented as dynamically linked libraries available to custom conversion library (218) at runtime, dynamically loaded Java classes, or any other implementation as will occur to those of skill in the art.

In the example of FIG. 1, the application messages (240) have a format specified in the message model (244). The message model (244) is metadata that defines the structure and the format used to create, access, and manipulate the application messages (240) converted from the application messages (241) received from the feed source (213). Typically the same message model (244) is established on the feed adapter (208) and the subscribing client device (210) by the stream administration server (212) when the stream administration server (212) brokers the message stream (280) to the subscribing client device (210). A message model may be implemented using a structured document, such as, for example, an XML document, a Java object, C++ object, or any other implementation as will occur to those of skill in the art.

In the example of FIG. 1, the conversion module (220), the custom conversion library (218), the conversion functions of the conversion function libraries (224), and the caching functions of the caching functions library (204) process the data contained in the application messages (240) using the message library (225). The message library (225) is a software module that includes a set of functions for creating, accessing, and manipulating messages (240) according to the message model (244). The message library (225) is accessible to the conversion module (220), the custom conversion library (218), the conversion functions of the conversion function libraries (224), and the caching functions of the caching functions library (204) through a message API (227) exposed by the message library (225).

Before the custom conversion library (218) of FIG. 1 performs data processing on the application messages, the custom conversion library (218) receives application messages (241) having an input message format from the feed source (213). The custom conversion library (218) of FIG. 1 may receive the source stream messages through a receiving transport engine (not shown) of the feed adapter (208). The receiving transport engine is a software module that operates in the transport layer of the network stack and may be implemented according to the TCP/IP protocols, UDP/IP protocols, or any other data communication protocol as will occur to those of skill in the art. The receiving transport engine may provide the received application messages (241) directly to the custom conversion library (218) or to the messaging middleware (276), which in turn, provides the source stream messages to the custom conversion library (218).

The messaging middleware (276) of FIG. 1 is a software component that provides high availability services between the feed adapter (208), any backup feed adapter that may exist, the subscribing client device (210), and the feed source (213). After the custom conversion library (218) of FIG. 1 performs data processing on the application messages (241) received from the feed source (213), the messaging middleware (276) receives the application messages (240) having an output message format from the custom conversion library (218). The messaging middleware (276) then provides the received application messages (240) having the output message format to the transport engine (278) for transmission to a subscribing client device (210) on the message stream (280). The custom conversion library (218) interacts with the messaging middleware (276) through a messaging middleware API (266) exposed by the messaging middleware (276).

The transport engine (278) of FIG. 1 is a software component operating in the transport and network layers of the OSI protocol stack promulgated by the International Organization for Standardization. The transport engine (278) provides data communications services between network-connected devices. The transport engine may be implemented according to the UDP/IP protocols, TCP/IP protocols, or any other data communications protocols as will occur to those of skill in the art. The transport engine (278) is a software module that includes a set of computer program instructions for application message caching according to embodiments of the present invention. The transport engine (278) operates generally for application message caching according to embodiments of the present invention by transmitting application messages (240) having an output message format to a message receiving device (210) on the message stream (280). The messaging middleware (276) operates the transport engine (278) through a transport API (268) exposed by the transport engine (278). The transport engine (278) transmits the application messages (240) by encapsulating the application messages provided by the messaging middleware (276) into packets and transmitting the packets through the message stream (280) to the subscribing client device (210).

The subscribing client device (210) in exemplary system of FIG. 1 connects to the high speed, low latency data communications network (200) through a wireline connection (264). The subscribing client device (210) of FIG. 1 is a computer device capable of subscribing to the message streams transmitted by various feed adapters. In a financial market data environment, for example, a subscribing client device may subscribe to a tick to receive the bid and ask prices for a particular security on a message stream provided by a feed adapter controlled by a financial securities broker.

In the example of FIG. 1, the subscribing client device (210) has installed upon it an application (238), a message library (248), a message model (244), messaging middleware (252), a stream administration library (272), and a transport engine (256). The application (238) is a software component that processes data contained in the application messages (240) received from the feed adapter (208). The application (238) may process the data for utilization by the subscribing client device (210) itself, for contributing the data to another feed adapter, or for contributing the data to some other device. In a financial market data environment, the application installed on the subscribing client device may be a program trading application that buys or sells financial securities based on the quoted prices contained in ticks. The application may also be a value-adding application that contributes information to a tick such as, for example, the best bid and ask prices for a particular security, that is not typically included in the ticks provided by the feed source (213). The subscribing client device may then transmit the ticks to a feed adapter for resale to other subscribing client devices.

The application (238) processes the data contained in the application messages (240) using the message library (248). The message library (248) is software module that includes a set of functions for creating, accessing, and manipulating messages (240) according to a message model (244). The message library (248) is accessible to the application (238) through a message API (250) exposed by the message library (248). Similar to the message library (225) installed on the feed adapter (208), the message library (248) of FIG. 1 interprets the received application messages (240) using the message model (244). As mentioned above, the message model (244) is metadata that specifies the structure and the format for interpreting the application messages (240) received on the message stream (280).

The communications between the subscribing client device (210) and the stream administration server (212) may be implemented using a stream administration library (272). The stream administration library (272) is a set of functions contained in dynamically linked libraries, statically linked libraries, or dynamically loaded Java classes available to the application (238) through a stream administration library API (274). Through the stream administration library (272), the application (238) of the subscribing client device (210) may request to subscribe to messages from a feed adapter, modify an existing message subscription, or cancel a subscription. Functions of the stream administration library (272) used by the application (238) may communicate with the stream administration server (212) through network (200) by calling member methods of a CORBA object, calling member methods of remote objects using the Java Remote Method Invocation (‘RMI’) API, using web services, or any other communication implementation as will occur to those of skill in the art.

‘CORBA’ refers to the Common Object Request Broker Architecture, a computer industry specifications for interoperable enterprise applications produced by the Object Management Group (‘OMG’). CORBA is a standard for remote procedure invocation first published by the OMG in 1991. CORBA can be considered a kind of object-oriented way of making remote procedure calls, although CORBA supports features that do not exist in conventional RPC. CORBA uses a declarative language, the Interface Definition Language (“IDL”), to describe an object's interface. Interface descriptions in IDL are compiled to generate ‘stubs’ for the client side and ‘skeletons’ on the server side. Using this generated code, remote method invocations effected in object-oriented programming languages, such as C++ or Java, look like invocations of local member methods in local objects.

The Java™ Remote Method Invocation API is a Java application programming interface for performing remote procedural calls published by Sun Microsystems™. The Java™ RMI API is an object-oriented way of making remote procedure calls between Java objects existing in separate Java™ Virtual Machines that typically run on separate computers. The Java™ RMI API uses a remote procedure object interface to describe remote objects that reside on the server. Remote procedure object interfaces are published in an RMI registry where Java clients can obtain a reference to the remote interface of a remote Java object. Using compiled ‘stubs’ for the client side and ‘skeletons’ on the server side to provide the network connection operations, the Java™ RMI allows a Java client to access a remote Java object just like any other local Java object.

Before the application (238) processes the data contained in the messages (240), the application (238) receives the messages (240) from the messaging middleware (252), which, in turn, receives the application messages (240) from the feed adapter (208) through the transport engine (256). The messaging middleware (252) is a software component that provides high availability services between the subscribing client device (210), the feed adapter (208), any backup feed adapters, and the stream administration module (212). In addition, the messaging middleware (252) provides message administration services for the stream administration server (212). Such message administration services may include restricting the ability of the application (238) to send and receive messages on a message stream to messages that satisfy certain constraints. The application (238) and the stream administration library (272) interact with the messaging middleware (252) through a messaging middleware API (254).

The transport engine (256) of FIG. 1 is a software component operating in the transport and network layers of the OSI protocol stack promulgated by the International Organization for Standardization. The transport engine (256) provides data communications services between network-connected devices. The transport engine may be implemented according to the UDP/IP protocols, TCP/IP protocols, or any other data communications protocols as will occur to those of skill in the art. The transport engine (256) is a software component that receives application message (240) from the feed adapter (208). The transport engine (256) receives the application messages (240) by receiving packets through the message stream (280) from the feed adapter (208), unencapsulating the application messages (240) from the received packets, and providing the application messages (240) to the messaging middleware (252). The messaging middleware (252) operates the transport engine (256) through a transport API (258) exposed by the transport engine (256).

The servers and other devices illustrated in the exemplary system of FIG. 1 are for explanation, not for limitation. Devices useful in application message caching in a feed adapter according to embodiments of the present invention may be implemented using general-purpose computers, such as, for example, computer servers or workstations, hand-held computer devices, such as, for example, Personal Digital Assistants (‘PDAs’) or mobile phones, or any other automated computing machinery configured for data processing according to embodiments of the present invention as will occur to those of skill in the art.

The arrangement of servers and other devices making up the exemplary system illustrated in FIG. 1 are for explanation, not for limitation. Although the connections to the network (200) of FIG. 1 are depicted and described in terms of wireline connections, readers will note that wireless connections may also be useful according to various embodiments of the present invention. Furthermore, data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example Transmission Control Protocol (‘TCP’), Internet Protocol (‘IP’), HyperText Transfer Protocol (‘HTTP’), Wireless Access Protocol (‘WAP’), Handheld Device Transport Protocol (‘HDTP’), and others as will occur to those of skill in the art. Various embodiments of the present invention may be implemented on a variety of hardware platforms in addition to those illustrated in FIG. 1.

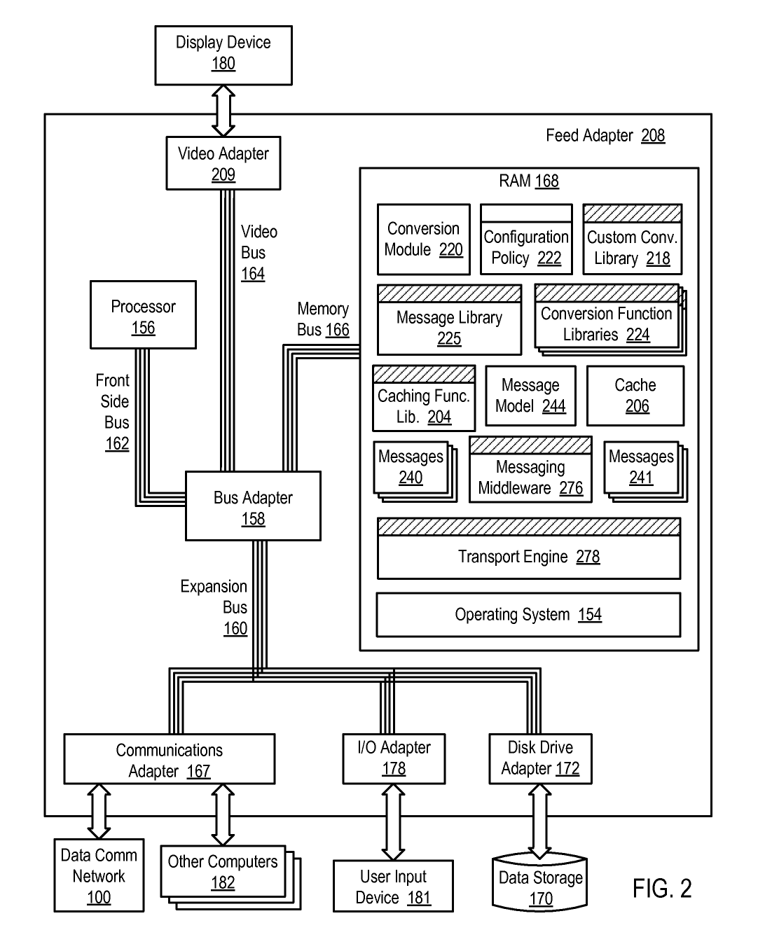

Application message caching in a feed adapter in accordance with the present invention in some embodiments may be implemented with one or more feed adapters, message receiving devices, and stream administration servers. These devices and servers are, in turn, implemented to some extent at least as computers, that is, automated computing machinery. For further explanation, therefore, FIG. 2 sets forth a block diagram of automated computing machinery comprising an exemplary feed adapter (208) useful in application message caching in a feed adapter according to embodiments of the present invention. The feed adapter (208) of FIG. 2 includes at least one computer processor (156) or ‘CPU’ as well as random access memory (168) (‘RAM’) which is connected through a high speed memory bus (166) and bus adapter (158) to processor (156) and to other components of the feed adapter.

Stored in RAM (168) are a conversion module (220), custom conversion library (218), a configuration policy (222), caching functions library (204), feed adapter cache (206), conversion function libraries (224), application messages (240), application messages (241), a message model (244), message library (225), messaging middleware (276), and transport engine (278). Each application message (240, 241) is a quantity of data that includes one or more data fields and is transmitted from one device to another on a message stream. Application messages are typically created and processed by applications operating in application layers above the network and transport layers of a network protocol stack. As mentioned above, an application message may represent numeric or textual information, images, encrypted information, computer program instructions, and so on. In a financial market data environment, for example, a message is commonly referred to as a ‘tick’ and includes financial market data such as, for example, financial quotes or financial news. Each application message (240, 241) may be implemented using a structured document such as, for example, an XML document, a Java object, C++ object, or any other implementation as will occur to those of skill in the art. The message model (244) is metadata that defines the structure and format for creating and interpreting the application messages (240) having an output message format. The message model (244) may be implemented using a structured document such as, for example, an XML document, a Java object, C++ object, or any other implementation as will occur to those of skill in the art. The conversion module (220), the custom conversion library (218), the configuration policy (222), caching functions library (204), feed adapter cache (206), the conversion function libraries (224), the message library (225), the messaging middleware (276), and the transport engine (278) illustrated in FIG. 2 are software components, that is computer program instructions, that operate as described above with reference to FIG. 1 regarding the feed adapter.

Also stored in RAM (168) is an operating system (154). Operating systems useful in feed adapters according to embodiments of the present invention include UNIX™, Linux™, Microsoft NT™, IBM's AIX™, IBM's i5/OS™, and others as will occur to those of skill in the art. The operating system (154), the conversion module (220), the custom conversion library (218), the configuration policy (222), the conversion function libraries (224), the application messages (240), the application messages (241), the message model (244), the message library (225), the messaging middleware (276), and the transport engine (278) in the example of FIG. 2 are shown in RAM (168), but many components of such software typically are stored in non-volatile memory also, for example, on a disk drive (170).

The exemplary feed adapter (208) of FIG. 2 includes bus adapter (158), a computer hardware component that contains drive electronics for high speed buses, the front side bus (162), the video bus (164), and the memory bus (166), as well as drive electronics for the slower expansion bus (160). Examples of bus adapters useful in feed adapters useful according to embodiments of the present invention include the Intel Northbridge, the Intel Memory Controller Hub, the Intel Southbridge, and the Intel I/O Controller Hub. Examples of expansion buses useful in feed adapters useful according to embodiments of the present invention may include Peripheral Component Interconnect (‘PCI’) buses and PCI Express (‘PCIe’) buses.

The exemplary feed adapter (208) of FIG. 2 also includes disk drive adapter (172) coupled through expansion bus (160) and bus adapter (158) to processor (156) and other components of the exemplary feed adapter (208). Disk drive adapter (172) connects non-volatile data storage to the exemplary feed adapter (208) in the form of disk drive (170). Disk drive adapters useful in feed adapters include Integrated Drive Electronics (‘IDE’) adapters, Small Computer System Interface (‘SCSI’) adapters, and others as will occur to those of skill in the art. In addition, non-volatile computer memory may be implemented in a feed adapter as an optical disk drive, electrically erasable programmable read-only memory (so-called ‘EEPROM’ or ‘Flash’ memory), RAM drives, and so on, as will occur to those of skill in the art.

The exemplary feed adapter (208) of FIG. 2 includes one or more input/output (‘I/O’) adapters (178). I/O adapters in feed adapters implement user-oriented input/output through, for example, software drivers and computer hardware for controlling output to display devices such as computer display screens, as well as user input from user input devices (181) such as keyboards and mice. The exemplary feed adapter (208) of FIG. 2 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary feed adapter (208) of FIG. 2 includes a communications adapter (167) for data communications with other computers (182) and for data communications with a high speed, low latency data communications network (200). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for application message caching in a feed adapter according to embodiments of the present invention include modems for wired dial-up communications, IEEE 802.3 Ethernet adapters for wired data communications network communications, and IEEE 802.11b adapters for wireless data communications network communications.

Although FIG. 2 is discussed with reference to exemplary feed adapters, readers will note that automated computing machinery comprising exemplary message receiving devices, such as, for example, subscribing client devices, and exemplary stream administration servers useful in application message caching in a feed adapter according to embodiments of the present invention are similar to the exemplary feed adapter (208) of FIG. 2. That is, such exemplary stream administration servers and feed adapters include one or more processors, bus adapters, buses, RAM, video adapters, communications adapters, I/O adapters, disk drive adapters, and other components similar to the exemplary feed adapter (208) of FIG. 2 as will occur to those of skill in the art.

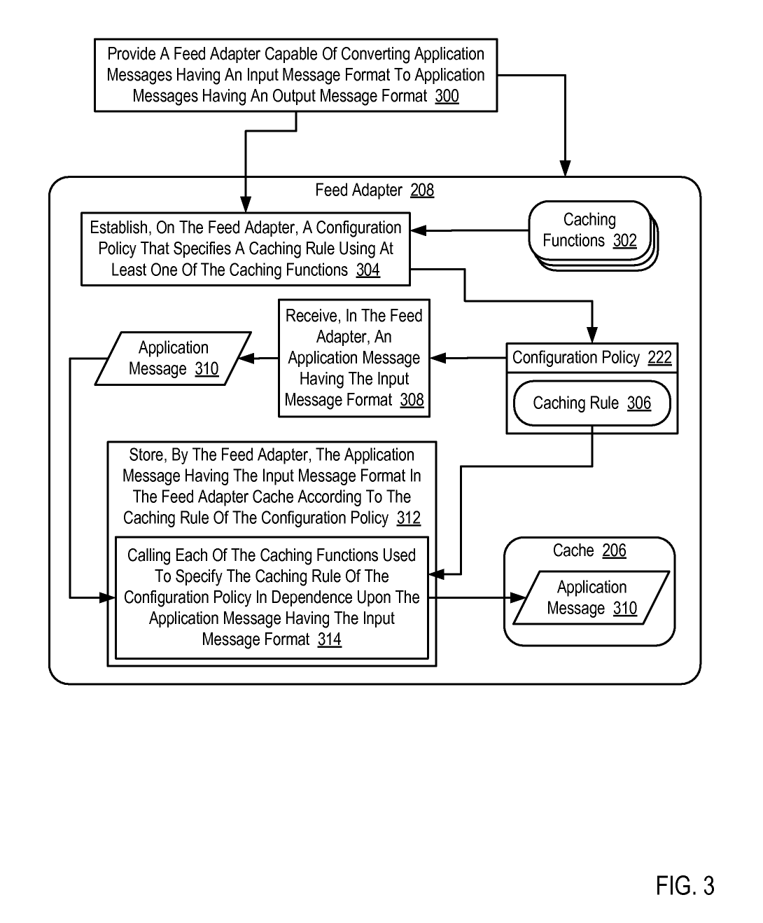

For further explanation, FIG. 3 sets forth a flowchart illustrating an exemplary method for application message caching in a feed adapter according to embodiments of the present invention. The method of FIG. 3 includes providing (300) a feed adapter (208) capable of converting application messages having an input message format to application messages having an output message format. The feed adapter (208) of FIG. 3 includes a feed adapter cache (206) and a plurality of caching functions (302) for administering the feed adapter cache (206). As mentioned above, the caching functions (302) may be contained in a caching function library that is loaded during the initialization of the feed adapter (208).

For addition explanation of the caching functions (302), consider the following exemplary conversion functions useful for application message caching in a feed adapter according to embodiments of the present invention:
void defineCache(int cachelD, string headerDefinition);
int setCache(int fieldID, int entryID, field_type value);
field_type getcache(int fieldID, int entryID);
field_type maxCache(int fieldID, int entryID, field_type comparevalue); and
field_type minCache(int fieldID, int entryID, field_type compareValue).

The exemplary caching functions above may be used by a feed adapter to administer a feed adapter cache. The exemplary function ‘defineCache’ configures the feed adapter cache identified by the value for ‘cacheID’ to store entries having fields defined by the value of the ‘headerDefinition.’ The exemplary function ‘setCache’ sets a value in the cache entry identified by the value for the ‘entryID’ at the field of the entry identified by the value for ‘fieldID.’ The exemplary function ‘setCache’ returns an integer to indicate whether the function was successful. The exemplary function ‘getCache’ retrieves the value from the cache entry identified by the value for the ‘entryID’ at the field of the entry identified by the value for ‘fieldID.’ The exemplary function ‘maxCache’ compares a comparison value with the value in the cache entry identified by the value for the ‘entryID’ at the field of the entry identified by the value for ‘fieldID.’ The exemplary function ‘maxCache’ then stores the maximum value in the cache and returns the maximum value in response to the function call. The exemplary function ‘minCache’ compares a comparison value with the value in the cache entry identified by the value for the ‘entryID’ at the field of the entry identified by the value for ‘fieldID.’ The exemplary function ‘minCache’ then stores the minimum value in the cache and returns the minimum value in response to the function call. Readers will note that the exemplary caching functions above are for explanation and not for limitation. Other caching functions as will occur to those of skill in the art may also be useful in application message caching in a feed adapter according to embodiments of the present invention.

The method of FIG. 3 also includes establishing (304), on the feed adapter (208), a configuration policy (222). The configuration policy (222) is a data structure specifies a caching rule (306) using at least one of the caching functions (302). The caching rule (306) is a data structure of the configuration policy (222) that contains a set of instructions for administering the feed adapter cache (206). Although the configuration policy (222) depicted in FIG. 3 includes only one caching rule (306), readers will note that a configuration policy useful according to the present invention may include any number of caching rules. In fact, a configuration policy according to the present invention often includes multiple caching rules because the configuration policy may specify a specific caching rule for each type of application message received from a feed source. In a financial market data environment, for example, the configuration policy may specify one caching rule for a message containing quote data for a security and another caching rule for a message containing sale data for a security.

In the example of FIG. 3, the configuration policy (222) may be established (304) on the feed adapter (208) by a system administrator, by a stream administration server that brokers the establishment of a message stream from the feed adapter (208) to a message receiving device, or any other entity as will occur to those of skill in the art. The configuration policy (222) of FIG. 3 may be implemented using a structured document such as, for example, an eXtensible Markup Language (‘XML’) document. For optimal runtime performance, however, the feed adapter (208) typically converts a configuration policy to a binary table. For further explanation of a configuration policy useful application message caching in a feed adapter according to embodiments of the present invention, consider the following exemplary configuration policy:

| | |
|---|---|
| 1: | <configuration_policy> |
| 2: | <load library=“CACHELIB1”> |
| 3: | <caching_rule intype=“Opra.Sale” symbol=“IBM”> |
| 4: | <action> |
| 5: | setCache(1, 1, opraMessage.LastSalePrice) |
| 6: | </action> |
| 7: | <action> |
| 8: | addCache(2, 1, opraMessage.Shares) |
| 9: | </action> |
| 10: | </caching_rule> |
| 11: | </configuration_policy> |

In the example above, lines 1 and 11 contain markup tags that denote the beginning and the end, respectively, of an exemplary configuration policy. Line 2 of the exemplary configuration policy instructs a feed adapter to load the caching function library identified as ‘CACHELIB1.’ The CACHELIB1 caching function library contains the function definitions of the caching functions specified in the exemplary configuration policy above. In the example above, lines 3 and 10 contain markup tags that denote the beginning and the end, respectively, of an exemplary caching rule specified by the exemplary configuration policy. The exemplary caching rule specifies two ‘actions’ to be performed by a feed adapter to administer a feed adapter cache when the feed adapter receives an application message having an OPRA format representing a sale of an IBM security on participating OPRA exchange. The first action instructs the feed adapter to execute a ‘setCache’ function capable of storing the last sale price of the IBM security in the feed adapter cache. The second action instructs the feed adapter to execute an ‘addCache’ function capable of adding the number of shares sold in the last transaction to the value for current daily volume of the IBM security. The feed adapter may use these values for the last sale price and the current daily volume stored in the cache by inserting these values into application messages containing data for the IBM security and transmitting such application message to message receiving devices. Readers will note that the exemplary configuration policy above is for explanation and not for limitation. Other configuration policies as will occur to those of skill in the art may also be useful in application message caching in a feed adapter according to embodiments of the present invention. Readers will also note that the XML implementation, the markup tags, and structure of the exemplary configuration policy above is also for explanation and not for limitation. Many other implementations, markup tags, or structures may be used to implement configuration policies useful according to embodiments of the present invention.

The method of FIG. 3 includes receiving (308), in the feed adapter, an application message (310) having the input message format. The feed adapter (208) may receive (308) the application message (310) having the input message format according to the method of FIG. 3 by receiving one or more transport packets from a feed source that includes the application message (310) having the input message format and unencapsulating the application message (310) from the received transport packets.

The method of FIG. 3 also includes storing (312), by the feed adapter, the application message (310) having the input message format in the feed adapter cache (206) according to the caching rule (306) of the configuration policy (222). Storing (312), by the feed adapter, the application message (310) having the input message format in the feed adapter cache (206) according to the caching rule (306) of the configuration policy (222) according to the method of FIG. 3 may be carried out by calling (314) each of the caching functions (302) used to specify the caching rule (306) of the configuration policy (222) in dependence upon the application message (310) having the input message format. In the method of FIG. 3, calling (314) each of the caching functions (302) used to specify the caching rule (306) of the configuration policy (222) may be carried out in a conversion module or a custom conversion library installed on the feed adapter (208).

As mentioned above, the caching functions (302) enable the feed adapter to administer the feed adapter cache (206). In the example of FIG. 3, therefore, one of the caching functions (302) is capable of configuring the feed adapter cache (206). For example, one of the caching functions may format the feed adapter cache, resize the number of entries in the cache, or remove the data stored in the cache. In addition to configuring the cache (206), one of the caching functions (302) is capable of retrieving a value from the application message having the input message format, and storing the retrieved valve in the feed adapter cache. Such a caching function may advantageously provide the ability to extract a value from a particular message field contained in particular application messages and to store those values as entries in the feed adapter cache (206).

In the example of FIG. 3, one of the caching functions (302) is also capable of calculating a new cache value in dependence upon a current cache value and the application message having the input message format, and storing the new cache valve in the feed adapter cache. By calculating a new cache value in dependence upon a current cache value and an application message, the feed adapter advantageously is able to provide in-line calculations during application message conversion. Such in-line calculations may include averaging the values for particular message fields contained in particular application messages over a time period, identifying the maximum value for particular message fields contained in particular application messages over a time period, identifying the minimum value for particular message fields contained in particular application messages over a time period, and so on.

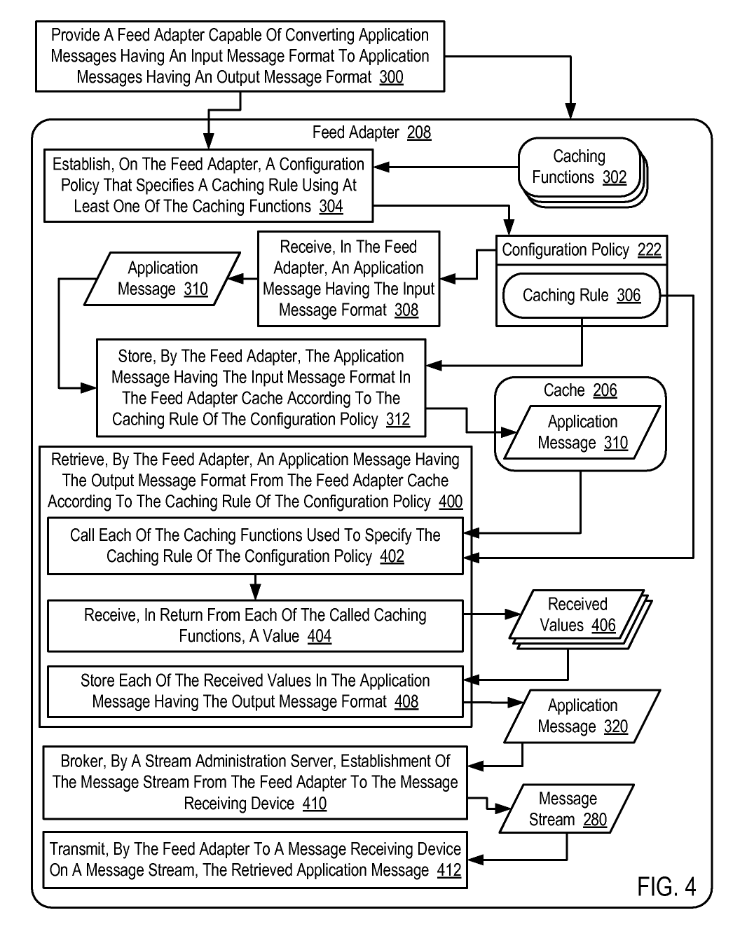

After a feed adapter stores the application message having the input message format in the feed adapter cache, the feed adapter may retrieve the application message having an output message format from the feed adapter cache and transmit the application message having the output message format to a message receiving device. For further explanation, therefore, FIG. 4 sets forth a flowchart illustrating a further exemplary method for application message caching in a feed adapter according to embodiments of the present invention that includes retrieving (400), by the feed adapter, an application message (320) having the output message format from the feed adapter cache according to the caching rule (306) of the configuration policy (222).

The method of FIG. 4 is similar to the method of FIG. 3. That is, the method of FIG. 4 includes providing (300) a feed adapter (208) capable of converting application messages having an input message format to application messages having an output message format. The feed adapter (208) of FIG. 4 includes a feed adapter cache (206) and a plurality of caching functions (302) for administering the feed adapter cache (206). The method of FIG. 4 is also similar to the method of FIG. 3 in that the method of FIG. 4 includes establishing (304), on the feed adapter, a configuration policy (222) that specifies a caching rule (306) using at least one of the caching functions (302), receiving (308), in the feed adapter, an application message (310) having the input message format, and storing (312), by the feed adapter, the application message (310) having the input message format in the feed adapter cache (206) according to the caching rule (306) of the configuration policy (222).

The method of FIG. 4 also includes retrieving (400), by the feed adapter, an application message (320) having the output message format from the feed adapter cache according to the caching rule (306) of the configuration policy (222). Retrieving (400), by the feed adapter, an application message (320) having the output message format from the feed adapter cache according to the caching rule (306) of the configuration policy (222) may be carried out by calling (402) each of the caching functions used to specify the caching rule (306) of the configuration policy (222), receiving (404), in return from each of the called caching functions, a value (406), and storing (408) each of the received values in the application message (320) having the output message format. In the method of FIG. 4, calling (402) each of the caching functions used to specify the caching rule (306), receiving (404), in return from each of the called caching functions, a value (406), and storing (408) each of the received values in the application message (320) may be carried out in a conversion module or a custom conversion library installed on the feed adapter (208).

For further explanation, consider an exemplary configuration policy useful for retrieving (400) an application message (320) having the output message format from the feed adapter cache that specifies a caching rule using a caching function that is capable of retrieving a cache value from the feed adapter cache and returning the retrieved cache value to calling entity. Such an exemplary configuration policy may be implemented in XML as follows:

| | |
|---|---|
| 1: | <configuration_policy> |
| 2: | <load library=“CACHELIB1”> |
| 3: | <caching_rule intype=“Opra.Sale” symbol=“IBM”> |
| 4: | <action field=“FMD.HighPrice”> |
| 5: | getCache(high_price, 1) |
| 6: | </action> |
| 7: | <action field=“FMD.LowPrice”> |
| 8: | getCache(low_price, 1) |
| 9: | </action> |
| 10: | <action field=“FMD.Volume”> |
| 11: | getCache(volume, 1) |
| 12: | </action> |
| 13: | </caching_rule> |
| 14: | </configuration_policy> |

In the example above, lines 1 and 14 contain markup tags that denote the beginning and the end, respectively, of an exemplary configuration policy. Line 2 of the exemplary configuration policy instructs a feed adapter to load the caching function library identified as ‘CACHELIB1.’ The CACHELIB1 caching function library contains the function definitions of the caching functions specified in the exemplary configuration policy above. In the example above, lines 3 and 13 contain markup tags that denote the beginning and the end, respectively, of an exemplary caching rule specified by the exemplary configuration policy. The exemplary caching rule specifies three ‘actions’ to be performed by a feed adapter to administer a feed adapter cache when the feed adapter receives an application message having an OPRA format representing a sale of an IBM security on participating OPRA exchange. The exemplary caching rule may be part of or follow a conversion rule in the exemplary configuration policy that specifies the conversion of an application message having an OPRA format to an application message having proprietary financial market data (‘FMD’) format.

The first action in the exemplary caching rule above instructs the feed adapter to execute a ‘getCache’ function capable of retrieving, from the cache, a value representing the highest price of the day for which the IBM security sold and returning the retrieved value in response to the function call. The first action further instructs the feed adapter to store the returned value representing the highest price in the ‘HighPrice’ field of the application message having the FMD format. The second action instructs the feed adapter to execute a ‘getCache’ function capable of retrieving, from the cache, a value representing the lowest price of the day for which the IBM security sold and returning the retrieved value in response to the function call. The second action further instructs the feed adapter to store the returned value representing the lowest price in the ‘LowPrice’ field of the application message having the FMD format. The third action instructs the feed adapter to execute a ‘getCache’ function capable of retrieving, from the cache, a value representing the total number of IBM securities traded for the day and returning the retrieved value in response to the function call. The third action further instructs the feed adapter to store the returned value representing the total number of IBM securities traded for the day in the ‘Volume’ field of the application message having the FMD format. Readers will note that the exemplary configuration policy above is for explanation and not for limitation. Other configuration policies as will occur to those of skill in the art may also be useful in application message caching in a feed adapter according to embodiments of the present invention. Readers will also note that the XML implementation, the markup tags, and structure of the exemplary configuration policy above is also for explanation and not for limitation. Many other implementations, markup tags, or structures may be used to implement configuration policies useful according to embodiments of the present invention.

The method of FIG. 4 also includes brokering (410), by a stream administration server, establishment of a message stream (280) from the feed adapter (208) to the message receiving device. The message stream (280) of FIG. 4 represents a data communication channel between a communications endpoint of a message receiving device and a communications endpoint of the feed adapter (208). A message stream may be implemented as a multicast data communication channel using the UDP/IP protocols or a unicast data communication channel using TCP/IP protocols as discussed above with reference to FIG. 1.

Brokering (410), by a stream administration server, establishment of a message stream (280) from the feed adapter (208) to the message receiving device according to the method of FIG. 4 may be carried out by receiving a subscription request from a message receiving device to subscribe to messages from the feed adapter (208). The subscription request may be implemented as an XML document, a call to a member method of a RMI object on the message receiving device, or any other implementation as will occur to those of skill in the art. The subscription request may include topics of the messages that the message receiving device requests to receive from the feed adapter (208). A topic represents the characteristics of the messages that the message receiving device requests. Using a topic, a message receiving device may specify the group of messages for receipt from the feed adapter (208). In a financial market data environment, for example, a message receiving device may use a topic to request ticks from an OPRA feed source that contains quotes of an IBM option traded on the Chicago Board Options Exchange (‘CBOE’) that includes the best bid and best ask for the IBM option on the CBOE.

In the example of FIG. 4, brokering (410), by a stream administration server, establishment of the message stream (280) from the feed adapter (208) to the message receiving device may also include providing the message receiving device with a destination address for the feed adapter (208). The destination address for the feed adapter (208) is a multicast address or a unicast address used by the message receiving device to listen for messages from the feed adapter (208). Using the destination address provided by the stream administration server, the message receiving device may establish the message stream (280) from the feed adapter (208) to the message receiving device.

Before the stream administration server provides the destination address for the feed adapter (208), the stream administration server in the example of FIG. 4 may perform several security services to ensure that the message receiving device only receives messages from the feed adapter (208) for which the message receiving device is authorized to receive. In the method of FIG. 4, brokering (410), by a stream administration server, establishment of the message stream (280) from the feed adapter (208) to the message receiving device may also be carried out by authenticating the message receiving device and authorizing the message receiving device to receive messages from the feed adapter (208) on the message stream (280). Authenticating the message receiving device may be carried out by verifying client security credentials provided by the message receiving device with the subscription request. The client security credentials may be implemented as a digital signature in a public key infrastructure, a security token, or any other security data as will occur to those of skill in the art for authenticating the identity of the originator of the subscription request. Authorizing the message receiving device to receive messages from the feed adapter (208) on the message stream (280) may be carried out by identifying the privileges associated with the authenticated message receiving device in dependence upon an authorization policy. An authorization policy is a set of rules governing the privileges of authenticated message receiving devices requesting to receive data from the feed adapter (208).

The method of FIG. 4 also includes transmitting (412), by the feed adapter to a message receiving device on a message stream (280), the retrieved application message (320). The feed adapter (208) may transmit (412) the application message (320) having the output message format to a message receiving device on a message stream (280) according to the method of FIG. 4 by encapsulating the application message (320) into one or more transport packets and transmitting the transport packets through the message stream (280) to the message receiving device according to the UDP/IP protocols, TCP/IP protocols, or any other data communications protocols as will occur to those of skill in the art.

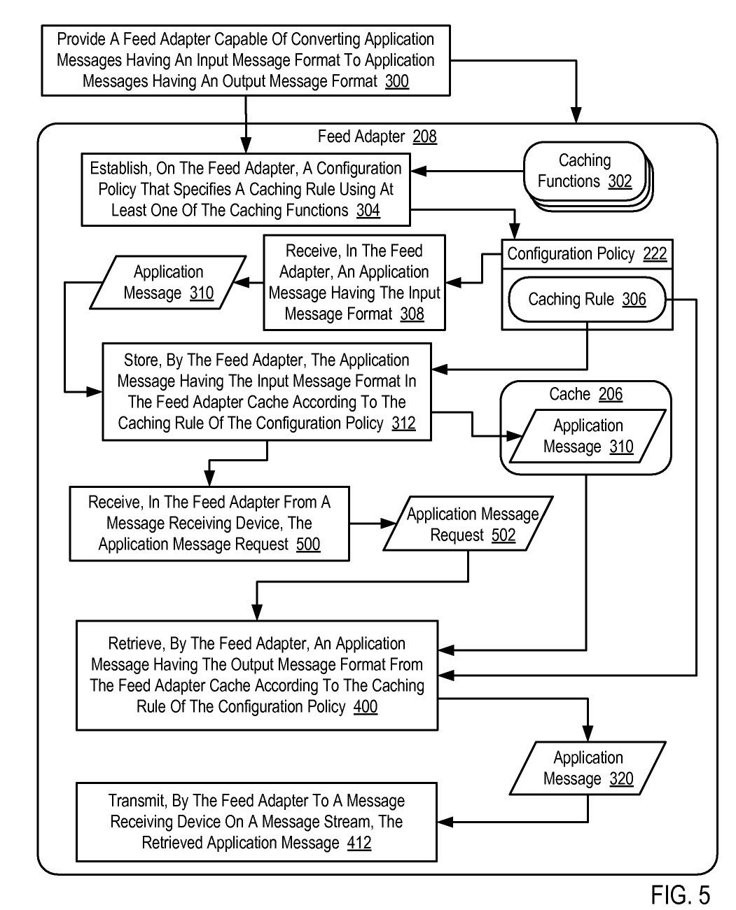

As mentioned above, a feed adapter may perform the set of instructions contain in a caching rule when conditions specified in the caching rule are satisfied. Readers will note that a feed adapter performs instructions contained the exemplary caching rules described above with reference to FIGS. 3 and 4 in response to receiving a particular type of application message from a feed source. A feed adapter may, however, perform instructions contained a caching rule in response to receiving an application message request from a message receiving device. For further explanation, therefore, FIG. 5 sets forth a flowchart illustrating a further exemplary method for application message caching in a feed adapter according to embodiments of the present invention that includes receiving (500), in the feed adapter from a message receiving device, the application message request (502).

The method of FIG. 5 is similar to the method of FIG. 3. That is, the method of FIG. 5 includes providing (300) a feed adapter (208) capable of converting application messages having an input message format to application messages having an output message format. The feed adapter (208) of FIG. 5 includes a feed adapter cache (206) and a plurality of caching functions (302) for administering the feed adapter cache (206). The method of FIG. 5 is also similar to the method of FIG. 3 in that the method of FIG. 5 includes establishing (304), on the feed adapter, a configuration policy (222) that specifies a caching rule (306) using at least one of the caching functions (302), receiving (308), in the feed adapter, an application message (310) having the input message format, and storing (312), by the feed adapter, the application message (310) having the input message format in the feed adapter cache (206) according to the caching rule (306) of the configuration policy (222).

The method of FIG. 5 also includes receiving (500), in the feed adapter (208) from a message receiving device, an application message request (502). The application message request (502) represents a request from a message receiving device for information stored in the feed adapter cache (206). In a financial market data environment, for example, an application message request may represent a request to a feed adapter from a message receiving device to provide information regarding the last sale price at which a particular IBM security sold. The message receiving device may request such an application message because the device may have not have previously received such information from the feed adapter (208). The application message request (502) of FIG. 5 may be implemented using a structured document, such as, for example, an XML document, a Java object, C++ object, or any other implementation as will occur to those of skill in the art. The feed adapter (208) may receive (500) the application message request (502) from the message receiving device through a data communications connection implemented using CORBA, the Java™ RMI API, web services, or any other communication implementation as will occur to those of skill in the art.

The method of FIG. 5 continues in a manner similar to the method of FIG. 4. That is, the method of FIG. 5 includes retrieving (400), by the feed adapter, an application message (320) having the output message format from the feed adapter cache according to the caching rule (306) of the configuration policy (222). In the example of FIG. 5, however, the caching rule specifies retrieval of an application message from the feed adapter cache in response to receiving an application message request. For further explanation, consider the following exemplary configuration policy:

| | |
|---|---|
| 1: | <configuration_policy> |
| 2: | <load library=“CACHELIB1”> |
| 3: | <caching_rule intype=“MessageRequest.LastSalePrice” |
| | Symbol=“IBM”> |
| 4: | <action field=“FMD.LastSalePrice”> |
| 5: | getCache(last_sale_price, 1) |
| 6: | </action> |
| 7: | <action> |
| 8: | routeMessage( ) |
| 9: | </action> |
| 10: | </caching_rule> |
| 11: | </configuration_policy> |

In the example above, lines 1 and 11 contain markup tags that denote the beginning and the end, respectively, of an exemplary configuration policy. In the example above, lines 3 and 10 contain markup tags that denote the beginning and the end, respectively, of an exemplary caching rule specified by the exemplary configuration policy. The exemplary caching rule specifies two ‘actions’ to be performed by a feed adapter to administer a feed adapter cache when the feed adapter receives an application message request to provide information regarding the last sale price at which a particular IBM security sold. The first action in the exemplary caching rule above instructs the feed adapter to execute a ‘getCache’ function capable of retrieving, from the cache, a value representing the last sale price at which the IBM security sold and returning the retrieved value in response to the function call. The first action further instructs the feed adapter to store the value representing the last sale price at which the IBM security sold in the ‘LastSalePrice’ field of the application message having the FMD format mentioned above. The second action specified in the caching rule instructs a feed adapter to route the application message having the FMD format to the appropriate message receiving device. Readers will note that the exemplary configuration policy above is for explanation and not for limitation. Other configuration policies as will occur to those of skill in the art may also be useful in application message caching in a feed adapter according to embodiments of the present invention. Readers will also note that the XML implementation, the markup tags, and structure of the exemplary configuration policy above is also for explanation and not for limitation. Many other implementations, markup tags, or structures may be used to implement configuration policies useful according to embodiments of the present invention.

The method of FIG. 5 also includes transmitting (412), by the feed adapter to a message receiving device on a message stream (280), the retrieved application message (320). The feed adapter (208) may transmit (412) the application message (320) having the output message format to a message receiving device on a message stream (280) according to the method of FIG. 4 by encapsulating the application message (320) into one or more transport packets and transmitting the transport packets through the message stream (280) to the message receiving device according to the UDP/IP protocols, TCP/IP protocols, or any other data communications protocols as will occur to those of skill in the art.

In view of the explanations set forth above in this document, readers will recognize that application message caching in a feed adapter according to embodiments of the present invention provides the following benefits:
the ability to modify application message caching operations performed by a feed adapter by only altering the feed adapter configuration policy,
the ability to extend feed adapter functionality using loadable a caching function library, and
the ability to reconfigure a feed adapter without recompiling the software installed on the feed adapter.

Exemplary embodiments of the present invention are described largely in the context of a fully functional computer system for application message caching in a feed adapter. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of application message caching in a feed adapter, the method comprising:
providing a feed adapter capable of converting application messages having an input message format to application messages having an output message format, the feed adapter comprising a feed adapter cache and a plurality of caching functions for administering the feed adapter cache;
establishing, on the feed adapter, a configuration policy that specifies a caching rule using at least one of the caching functions;
receiving, in the feed adapter, an application message having the input message format; and
storing, by the feed adapter, the application message having the input message format in the feed adapter cache according to the caching rule of the configuration policy.

2. The method of claim 1 wherein storing, by the feed adapter, the application message having the input message format in the feed adapter cache according to the caching rule of the configuration policy further comprises:
calling each of the caching functions used to specify the caching rule of the configuration policy in dependence upon the application message having the input message format.

3. The method of claim 1 further comprising:
retrieving, by the feed adapter, an application message having the output message format from the feed adapter cache according to the caching rule of the configuration policy; and
transmitting, by the feed adapter to a message receiving device on a message stream, the retrieved application message.

4. The method of claim 3 further comprising brokering, by a stream administration server, establishment of the message stream from the feed adapter to the message receiving device.

5. The method of claim 3 wherein retrieving, by the feed adapter, an application message having the output message format from the feed adapter cache according to the caching rule of the configuration policy further comprises:
calling each of the caching functions used to specify the caching rule of the configuration policy;
receiving, in return from each of the called caching functions, a value; and
storing each of the received values in the application message having the output message format.

6. The method of claim 3 wherein the caching rule specifies retrieval of an application message from the feed adapter cache in response to receiving an application message request, and the method further comprises receiving, in the feed adapter from a message receiving device, the application message request.

7. The method of claim 3 wherein the message receiving device is a subscribing client device.

8. The method of claim 1 wherein one of the caching functions is capable of:
retrieving a value from the application message having the input message format; and
storing the retrieved valve in the feed adapter cache.

9. The method of claim 1 wherein one of the caching functions is capable of:
calculating a new cache value in dependence upon a current cache value and the application message having the input message format; and
storing the new cache valve in the feed adapter cache.

10. The method of claim 1 wherein one of the caching functions is capable of:
retrieving a cache value from the feed adapter cache; and
returning the retrieved cache value.

11. The method of claim 1 wherein the application message further comprises financial market data.

12. An apparatus for application message caching in a feed adapter, the apparatus comprising a computer processor, a computer memory operatively coupled to the computer processor, the computer memory having disposed within it computer program instructions capable of:
providing a feed adapter capable of converting application messages having an input message format to application messages having an output message format, the feed adapter comprising a feed adapter cache and a plurality of caching functions for administering the feed adapter cache;
establishing, on the feed adapter, a configuration policy that specifies a caching rule using at least one of the caching functions;
receiving, in the feed adapter, an application message having the input message format; and
storing, by the feed adapter, the application message having the input message format in the feed adapter cache according to the caching rule of the configuration policy.

13. The apparatus of claim 12 wherein storing, by the feed adapter, the application message having the input message format in the feed adapter cache according to the caching rule of the configuration policy further comprises:
calling each of the caching functions used to specify the caching rule of the configuration policy in dependence upon the application message having the input message format.

14. The apparatus of claim 12 further comprising computer program instructions capable of:
retrieving, by the feed adapter, an application message having the output message format from the feed adapter cache according to the caching rule of the configuration policy; and
transmitting, by the feed adapter to a message receiving device on a message stream, the retrieved application message.

15. A computer program product for application message caching in a feed adapter, the computer program product disposed upon a signal bearing medium, the computer program product comprising computer program instructions capable of:
establishing, on a feed adapter capable of converting application messages having an input message format to application messages having an output message format, a configuration policy that specifies a caching rule using at least one of a plurality of caching functions comprised on the feed adapter, the plurality of caching functions capable of administering a feed adapter cache also comprised on the feed adapter;
receiving, in the feed adapter, an application message having the input message format; and
storing, by the feed adapter, the application message having the input message format in the feed adapter cache according to the caching rule of the configuration policy.

16. The computer program product of claim 15 wherein the signal bearing medium comprises a recordable medium.

17. The computer program product of claim 15 wherein the signal bearing medium comprises a transmission medium.

18. The computer program product of claim 15 wherein storing, by the feed adapter, the application message having the input message format in the feed adapter cache according to the caching rule of the configuration policy further comprises:
calling each of the caching functions used to specify the caching rule of the configuration policy in dependence upon the application message having the input message format.

19. The computer program product of claim 15 further comprising computer program instructions capable of:
retrieving, by the feed adapter, an application message having the output message format from the feed adapter cache according to the caching rule of the configuration policy; and
transmitting, by the feed adapter to a message receiving device on a message stream, the retrieved application message.

20. The computer program product of claim 19 wherein retrieving, by the feed adapter, an application message having the output message format from the feed adapter cache according to the caching rule of the configuration policy further comprises:
calling each of the caching functions used to specify the caching rule of the configuration policy;
receiving, in return from each of the called caching functions, a value; and
storing each of the received values in the application message having the output message format.
